(19) United States
(12) Patent Application Publication
(10) Pub. No.: US 2026/0193748 A1
(43) Pub. Date: Jul. 9, 2026

(54) METAL MATRIX COMPOSITES FOR DRILLING TOOLS

(71) Applicant: SCHLUMBERGER TECHNOLOGY CORPORATION, Sugar Land, TX (US)

(72) Inventors: Mingdong CAI, Houston, TX (US); Huimin SONG, Houston, TX (US); Youhe ZHANG, Houston, TX (US); Ting REN, Houston, TX (US)

(21) Appl. No.: 19/133,738

(22) PCT Filed: Nov. 28, 2023
(86) PCT No.: PCT/US2023/081362

§ 371 Date: May 29, 2025

Related U.S. Application Data
(60) Provisional application No. 63/385,227, filed on Nov. 29, 2022.

(51) Int. Cl. C22C 29/08; B22F 10/28; B33Y 10/00; B33Y 70/10; B33Y 80/00; C22C 1/10; C22C 29/00; E21B 10/46

(52) U.S. Cl. CPC C22C 29/08; B33Y 70/10; B33Y 80/00; C22C 1/1068; C22C 29/005; B22F 10/28; B33Y 10/00; E21B 10/46

(57) ABSTRACT

An additively manufactured metal matrix composite (MMC) includes hard particles and a binder. The hard particles are greater than 27 vol % of the MMC, and are spherically shaped. The binder includes at least nickel and silicon. The binder is less than 73 vol % of the MMC. The silicon is more than 6.0 wt % of the binder yet less than 12.5 wt % of the binder. A transverse rupture strength (TRS) of the MMC is greater than 200 ksi, and the erosion resistance factor is greater than 30.

### CROSS-REFERENCE TO RELATED APPLICATIONS

This application claims the benefit of U.S. Provisional Application No. 63/385,227, entitled “METAL MATRIX COMPOSITES FOR DRILLING TOOLS,” filed Nov. 29, 2022, the disclosure of which is hereby incorporated herein by reference.

### BACKGROUND OF THE DISCLOSURE

Wellbores are drilled into a surface location or seabed for a variety of exploratory or extraction purposes. For example, a wellbore may be drilled to access fluids, such as liquid and gaseous hydrocarbons, stored in subterranean formations and to extract the fluids from the formations. A variety of drilling methods may be utilized depending partly on the characteristics of the formation through which the wellbore is drilled.

During drilling of a wellbore, cutting tools such as drill bits and reamers are used to remove material from the earth to extend or enlarge the wellbore. Typically, cutting tools include an integral bit body which may be made of steel or fabricated from a hard, composite matrix material composed of tungsten carbide and a metal binder. Cutting elements are mounted along the exterior face of blades of the bit body. Cutting elements for use in earth-boring drill bits may include polycrystalline diamond compact (PDC) cutters. Each PDC cutter has a portion which is brazed in a recess or pocket formed in the blade.

The PDC cutters are positioned along the leading edges of the bit body blades so that as the bit body is rotated, the PDC cutters engage and drill the earth formation. In use, high forces may be exerted on the PDC cutters. Additionally, the bit and the PDC cutters may be subjected to substantial abrasive forces. In some instances, impact, vibration, and erosive forces have caused drill bit failure due to loss of one or more cutters, or due to breakage of the blades.

While steel body bits may have toughness and ductility properties which make them resistant to cracking and failure due to impact forces generated during drilling, steel is more susceptible than matrix material to abrasive and erosive wear caused by high-velocity drilling fluids and abrasive particles. The abrasive particles may include portions of the formation carried by drilling fluids, as well as sand, rock cuttings, and the like. Generally, portions of steel body PDC bits are coated with a more erosion-resistant material, such as tungsten carbide hardfacing, to improve erosion resistance.

Tungsten carbide (WC) hard metal matrix body bits have higher wear and erosion resistance as compared to steel bit bodies. A typical matrix bit used in the industry today is generally formed by packing a mold with tungsten carbide powder and then infiltrating the powder with a molten transition metal alloy. Common metal alloys for forming the metal matrix are iron, nickel, copper, or alloys thereof.

Bit bodies formed from tungsten carbide or other hard metal matrix materials, while more erosion resistant than steel, lack toughness and strength, thus making them brittle and susceptible to cracking when subjected to impact and fatigue forces encountered during drilling. This can result in one or more blades cracking or even breaking off the bit. The formation and propagation of cracks in the matrix body may result in the loss of one or more PDC cutters.

Cutting tools in the downhole drilling environment encounter harsh conditions such as abrasion, erosion, impact, torque, and fatigue. These conditions decrease the effective life of bit bodies. It may be advantageous to modify the materials and construction of cutting tools.

### SUMMARY

An additively manufactured metal matrix composite (MMC) includes hard particles and a binder. The hard particles are greater than 27 vol % of the MMC, and are spherically shaped. For example, spherically cast tungsten carbide particles are greater than 40 wt % of the MMC. The binder includes at least nickel and silicon. The binder is less than 73 vol % of the MMC. For example, the binder is less than 60 wt % of the MMC having SCC particles. The silicon is more than 6.0 wt % of the binder yet less than 12.5 wt % of the binder.

Additively manufacturing a metal matrix composite (MMC) includes printing a first layer of the MMC and printing a second layer of the MMC at least partially on the first layer. Each layer of the MMC includes a mixture of hard particles and a binder powder. The hard particles include between 30 vol % and 50 vol % of the MMC. The binder powder includes nickel and silicon. The silicon is more than 6.0 wt % of the binder powder and less than 10.0 wt % of the binder powder.

A drilling tool having an additively manufactured metal matrix composite (MMC) includes hard particles and a binder having nickel and silicon. The hard particles include more than 30 vol % of the MMC, and are spherically shaped cast tungsten carbide particles. The binder includes less than 70 vol % of the MMC. The silicon includes more than 7.0 wt % of the binder and less than 10.0 wt % of the binder.

This summary is provided to introduce a selection of concepts that are further described in the detailed description. This summary is not intended to identify key or essential features of the claimed subject matter, nor is it intended to be used as an aid in limiting the scope of the claimed subject matter. Additional features and aspects of embodiments of the disclosure will be set forth herein, and in part will be obvious from the description, or may be learned by the practice of such embodiments.

### BRIEF DESCRIPTION OF THE DRAWINGS

In order to describe the manner in which the above-recited and other features of the disclosure can be obtained, a more particular description will be rendered by reference to specific embodiments thereof which are illustrated in the appended drawings. For better understanding, the like elements have been designated by like reference numbers throughout the various accompanying figures. While some of the drawings may be schematic or exaggerated representations of concepts, at least some of the drawings may be drawn to scale. Understanding that the drawings depict some example embodiments, the embodiments will be described and explained with additional specificity and detail through the use of the accompanying drawings in which:

FIG. 1 is a representation of a drilling system, according to at least one embodiment of the present disclosure;

FIG. 2 is a side view of a downhole tool, according to one or more embodiments of the present disclosure;

FIG. 3 is an assembly view of a downhole tool with a metal matrix composite (MMC) segment and cutting elements, according to one or more embodiments of the present disclosure;

FIG. 4 is a sectional micrograph of an example MMC, according to one or more embodiments of the present disclosure;

FIG. 5 is a sectional micrograph of an example MMC, according to one or more embodiments of the present disclosure;

FIG. 6 is a chart noting the relationship between the transverse rupture strength (TRS) and an erosion resistance factor for multiple materials that may be used with downhole tools, according to one or more embodiments of the present disclosure;

FIG. 7 is a chart noting the TRS for multiple materials that may be used with downhole tools; according to one or more embodiments of the present disclosure;

FIG. 8 is a scanning electron microscopic image of an MMC having a nickel-based binder with silicon and boron, according to one or more embodiments of the present disclosure;

FIG. 9 is a scanning electron microscopic image of an MMC having a nickel-based binder with silicon yet without boron, according to one or more embodiments of the present disclosure;

FIG. 10 is a scanning electron microscope image of a fractured surface of an MMC;
according to one or more embodiments of the present disclosure

FIG. 11 is a scanning electron microscope image of a fractured surface of an MMC, according to one or more embodiments of the present disclosure

FIG. 12 is a chart illustrating the TRS of multiple MMC samples with binders having various quantities of silicon, according to one or more embodiments of the present disclosure;

FIG. 13 is a chart illustrating the microhardness of various binders, according to one or more embodiments of the present disclosure; and

FIG. 14 is a chart illustrating the erosion resistance factor of multiple MMC samples with binders having various quantities of silicon, according to one or more embodiments of the present disclosure.

### DETAILED DESCRIPTION

This disclosure generally relates to devices, systems, and methods for forming a bit, downhole tool, or component thereof for use in downhole drilling. Portions of a bit or other downhole tool operate in high stress environments and are susceptible to wear. Surfaces or portions of such bits and downhole tools may utilize materials having high strength and erosion resistance. Additive manufacturing may be utilized to form high strength and erosion resistant components. Such components may be integrally formed with the downhole tool, coupled to one or more surfaces, or otherwise applied to a downhole tool such as a drill bit.

According to embodiments of the present disclosure, the downhole tool may include any downhole tool, including a bit, reamers, hole openers, mills, casing cutters, stabilizers, bi-center bits, and so forth. While embodiments of the present disclosure may be described in reference to a bit, it should be understood that the embodiments described herein may refer to any downhole tool.

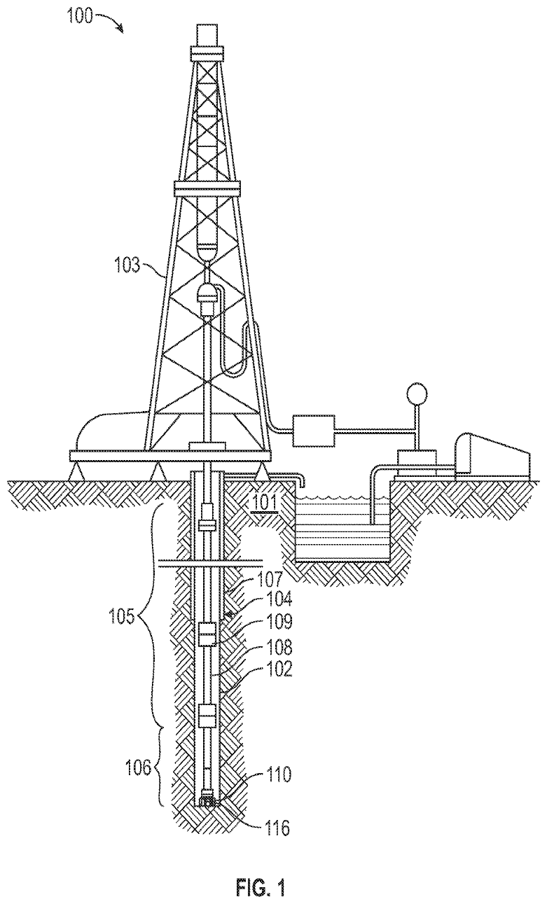

FIG. 1 shows one example of a drilling system 100 for drilling an earth formation 101 to form a wellbore 102. The drilling system 100 includes a drill rig 103 used to turn a drilling tool assembly 104 which extends downward into the wellbore 102. The drilling tool assembly 104 may include a drill string 105, a bottomhole assembly (“BHA”) 106, and a bit 110, attached to the downhole end of drill string 105.

The drill string 105 may include several joints of drill pipe 108 connected end-to-end through tool joints 109. The drill string 105 transmits drilling fluid through a central bore and transmits rotational power from the drill rig 103 to the BHA 106. In some embodiments, the drill string 105 may further include additional components such as subs, pup joints, etc. The drill pipe 108 provides a hydraulic passage through which drilling fluid is pumped from the surface. The drilling fluid discharges through selected-size nozzles, jets, or other orifices in the drill string 105 or bit 110 for the purposes of cooling the bit 110 and cutting structures thereon, and for lifting cuttings out of the wellbore 102 as it is being drilled.

The BHA 106 may include the bit 110 or other components. An example BHA 106 may include additional or other components (e.g., coupled between to the drill string 105 and the bit 110). Examples of additional BHA components include drill collars, stabilizers, measurement-while-drilling (“MWD”) tools, logging-while-drilling (“LWD”) tools, downhole motors, underreamers, section mills, hydraulic disconnects, jars, vibration or dampening tools, other components, or combinations of the foregoing. The BHA 106 may further include a rotary steerable system (RSS). The RSS may include directional drilling tools that change a direction of the bit 110, and thereby the trajectory of the wellbore. At least a portion of the RSS may maintain a geostationary position relative to an absolute reference frame, such as gravity, magnetic north, and/or true north. Using measurements obtained with the geostationary position, the RSS may locate the bit 110, change the course of the bit 110, and direct the directional drilling tools on a projected trajectory.

In general, the drilling system 100 may include other drilling components and accessories, such as special valves (e.g., kelly cocks, blowout preventers, and safety valves). Additional components included in the drilling system 100 may be considered a part of the drilling tool assembly 104, the drill string 105, or a part of the BHA 106 depending on their locations in the drilling system 100.

The bit 110 in the BHA 106 may be any type of bit suitable for degrading downhole materials. For instance, the bit 110 may be a drill bit suitable for drilling the earth formation 101. Example types of drill bits used for drilling earth formations are fixed-cutter or drag bits. In other embodiments, the bit 110 may be a mill used for removing metal, composite, elastomer, other materials downhole, or combinations thereof. For instance, the bit 110 may be used with a whipstock to mill into casing 107 lining the wellbore 102. The bit 110 may also be a junk mill used to mill away tools, plugs, cement, other materials within the wellbore 102, or combinations thereof. Swarf or other cuttings formed by use of a mill may be lifted to surface or may be allowed to fall downhole.

In some embodiments, the bit 110 may include one or more cutting elements 116. As the bit 110 rotates, the cutting elements 116 may erode the formation 101, advancing the wellbore 102. Cuttings, the formation, drilling fluid, and other drilling elements may wear the bit 110 and/or the cutting elements 116. A hardfacing material placed on high-wear portions of the bit 110 may reduce wear on the bit 110. According to embodiments of the present disclosure, the hardfacing material may include a pre-sintered blade cover that at least partially surrounds at least one cutting element 116 of the bit 110. This may help to reduce wear on the bit 110.

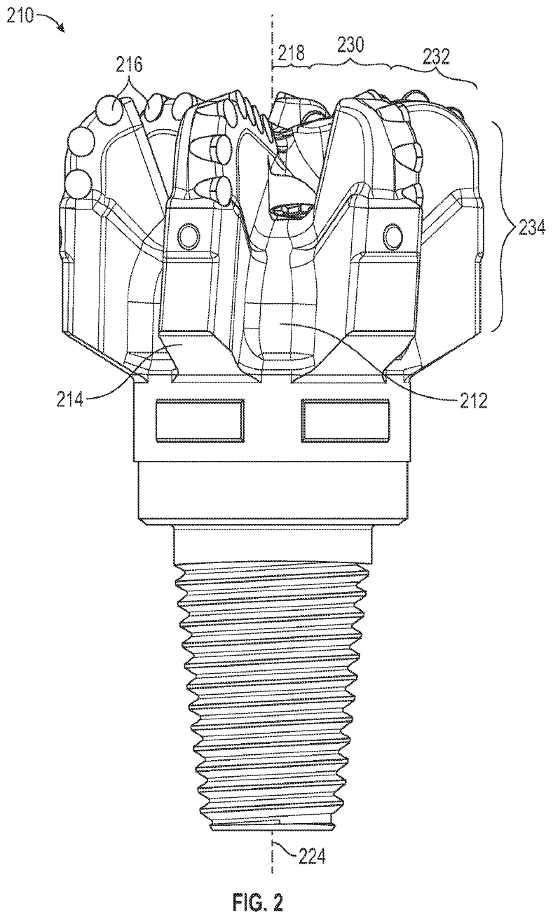

FIG. 2 is a perspective view of the downhole end of a bit 210, according to some embodiments of the present disclosure. The bit 210 in FIG. 2 is an example of a fixed-cutter or drag bit, and includes a bit body 212, and a plurality of blades 214 extending radially and in an axial direction therefrom. One or more of the blades 214—and potentially each blade 214—has a plurality of cutting elements 216 connected thereto. In some embodiments, at least one of the cutting elements 216 has a planar cutting face. A planar cutting face can be used to shear the downhole materials, and such a cutting element is considered a shear cutting element. In other embodiments, at least one of the cutting elements 216 has a non-planar cutting face. A non-planar cutting face shears, impacts/gouges, or otherwise degrades the downhole materials. Examples of non-planar cutting elements (i.e., cutting elements having a non-planar cutting face) include cutting elements with conical, ridged, domed, saddle-shaped, chisel-shaped, scoop-shaped, or other non-planar cutting faces.

The cutting elements 216 of the bit 210 can experience different wear rates in different regions of the bit body 212 or blades 214. The cutting elements 216 of the bit 210 experience different wear rates at a cone region 228, a nose region 230, a shoulder region 232, or a gage region 234 of the blades 214. For example, the cutting elements 216 of the nose region 230 can experience higher wear rates than the cutting elements 216 of the gage region 234. In other examples, the cutting elements 216 of the shoulder region 232 experience higher wear rates than the cutting elements 216 of the nose region 230.

Therefore, the bit body 212, the blades 214, or combinations thereof can include one or more body materials, such as a steel or carbide matrix. As provided herein, the bit 210 includes a second material, the present composite materials, that are harder and/or have higher wear or erosion resistance than the body material.

Conventionally, hardfacing has been applied to a steel bit to increase the wear and/or erosion resistance of certain areas on the bit, such as the formation facing surfaces of the blades and the gauge region. Hardfacing, however, is conventionally a manual process that applies a melted material, such as a spray or rod. The melted material is applied to the bit, and the material cools on the bit to have a final geometry. Because it is a manual process, hardfacing can be variable and subject to defects resulting in premature failure of the hardfacing and/or the hardface components at or near the defects. For example, the hardfacing can fail at boundaries, along compositional changes, at layers, or other inconsistencies in the hardfacing material. In other examples, the hardfacing delaminates from the downhole tool due to insufficient bond strengths and/or high residual stress between the hardfacing material and the downhole tool. Moreover, the heat applied to the bit near cutter pockets by the hardfacing process may degrade the base steel body material, which could lead to poor bonding strength between the cutting element 216 and the cutter pocket.

In accordance with one or more embodiments of the present disclosure, portions of the bit body 212, the blades 214, or both may be formed from a metal matrix composite (MMC). Pre-formed MMC segments may be joined to the bit body 212 or blades 214 formed of a different material. For example, MMC segments may be joined to a steel body bit. In another example, an MMC segment having a first composition may be joined to a matrix body bit having a second composition.

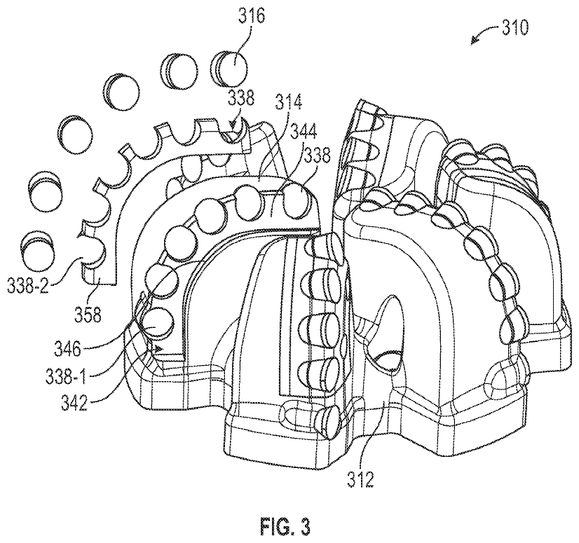

FIG. 3 is a partially-exploded side view of an embodiment of a drill bit 310 having a segment 358 formed from a MMC and attachable to a blade 314. The MMC of the present disclosure may form segments 358 that are attached to the blade 314 to form at least a portion of a blade, such as a leading surface, an outer surface, a trailing surface, or any combination thereof. In some embodiments, the MMC segments 358 are arranged on one or more formation-facing surfaces of the drill bit 310. The MMC segment 358 may at least partially define one or more cutter pockets 338 with the blade 314. Regardless of which component of the drill bit 310 the cutter pocket 338 is formed, each cutter pocket 338 may be configured to receive a respective cutting element 316 (e.g., planar cutting element, non-planar cutting element). For example, the blade 314 may form a base and part of a side of a cutter pocket 338-1, and the MMC segment 358 may at least partially form the side of the cutter pocket 338-2. In some embodiments, the MMC segment 358 may fully define one or more cutter pockets 338. The MMC segment 358 may be coupled to a recess 342 of the blade 314, wherein the recess 342 includes a back surface 344 and a side surface 346. The MMC segment 358 may be coupled to the blade 314 by brazing, a mechanical fastener, or a weld, among other means. The MMC segment 358 may be formed into various shapes for arrangement with the bit 310 as described in U.S. Pat. No. 11,313,176, U.S. Patent Application 2020/0123858, and International Patent Application PCT/US2021/047731, which are herein incorporated by reference.

Downhole tools, such as the drill bit 310, may utilize MMC segments having improved properties of strength and erosion/wear resistance. Arrangement of the MMC segments on a bit body 312 and/or blades 314 may combine benefits from utilizing a first material (e.g., steel) for the bit body 312 with benefits of the MMC as described herein. In some embodiments, the bit body material and/or blade material is a material with a lower erosion and/or wear resistance than the MMC segment material. In other embodiments, the bit body material and/or blade material is a material with higher toughness than the MMC segment material. In some examples, the bit body material and/or blade material includes a steel alloy and the MMC segment material includes a carbide (e.g., tungsten carbide). The steel alloy may have a higher toughness than the tungsten carbide, which is more brittle, and the carbide may provide greater wear and/or erosion resistance during cutting operations.

Generally, MMCs are composite materials formed of two or more constituents, where at least one of the constituents is a metal, and one or more other constituents may be metals or non-metals, including ceramics or organic compounds. Such other constituents may include a reinforcing material that is dispersed and embedded into a continuous metal matrix. The metal matrix may be formed of a binder material that at least partially melts to bond with the reinforcing material. The reinforcing material can be hard particles used to provide, for example, wear and erosion resistance to the continuous metal matrix. Examples of hard particles that may be used with the MMCs described herein include tungsten carbide, such as cast tungsten carbide (including spherical or angular particles), macrocrystalline tungsten carbide, carburized tungsten carbide, sintered tungsten carbide pellets, titanium carbide, silicon carbide, or combinations of the foregoing.

MMCs may be formed through a variety of processes. Typical matrix bit bodies are MMCs formed by infiltration of a porous powder or component with a molten material (e.g., metallic binder). For example, a mold for the bit body may be formed, and then packed with a tungsten carbide powder. The powder may be infiltrated with a molten transition metal alloy to form the matrix bit body. Additive manufacturing (AM) may be used to form MMCs that form a bit body or a portion of a bit, such as a segment that may be coupled to a bit body. Example additive manufacturing processes include, but are not limited to, powder bed fusion, binder jetting, infiltration/casting, laser deposition, or cladding. Powder bed fusion techniques may include, for example, high energy fusion techniques that include direct metal laser sintering (DMLS), electron beam melting (EBM), selective heat sintering (SHS), selective laser melting (SLM), and selective laser sintering (SLS). In one or more particular embodiments, the MMC may be formed layer-by-layer using EBM where sequential layers of a mixture of hard material and binder power are deposited and the metal phase, or binder, is sintered or otherwise melted to form a dense, solid composite. An MMC formed by an EBM may be fully dense such that subsequent appreciable infiltration does not occur or cannot occur.

In at least some embodiments, materials of the present disclosure may be used to produce a drill bit, other cutting tool or downhole tool, or a component thereof in a manner that either cannot be formed using other techniques such as infiltration, or which would result in a product with properties that are physically very different. For instance, when small particle sizes are used in a high energy fusion manufacturing technique such as EBM, a vacuum environment may be used. Without a vacuum environment, small particle sizes may not be suitably infiltrated, as the capillary connection is not strong, and voids are not connected, thereby leading to limited flow of binder materials. Additionally, at elevated infiltration temperatures carbide or other hard particles may be damaged such that traditional infiltration is undesirable. For instance, particularly for cast carbide and nickel, iron, or cobalt binder, infiltration at temperatures similar to those used in high energy fusion techniques may generate an Eta phase in the carbide, resulting in a drop in transverse rupture strength and toughness, and increased brittleness of the material. Further still, high energy fusion techniques may be used to deposit and fuse hard particles and binder materials in layers that can have a relatively consistent hard particle weight and volume percentage. In contrast, and particularly for compositions having relatively lower hard particle volume percentages, infiltration techniques would result in settling of the hard particles toward the bottom of a mold, resulting in a bit having a dramatic gradient in the hard particle weight and volume percentages, and thus having significantly less hard particle volume and mass at the top of the molded part. As a result, a component formed of relatively low hard particle volumes have significantly different physical properties when produced layer-by-layer using a high energy fusion technique, than when produced using an infiltration or molding procedure.

Additive manufacturing by EBM may form MMC segments designed with a 3D CAD model. The 3D CAD model may be printed in successive layers of the powdered material by an EBM machine. EBM machines, such as the Arcam EBM Spectra H available from GE, may facilitate printing of MMC segments that closely match the 3D CAD models. In some embodiments, the MMC segments may be printed with a minimum layer thickness of 0.05 mm with a tolerance of ±0.4 mm. The MMC segments to be printed may be arranged within a build space of an AM system (e.g., an EBM machine) in various orientations to increase the packing density of MMC segments within the build space. The MMC segments may be arranged within the build space of AM system such that the MMC segments are sufficiently supported during printing and spaced appropriately so that the solidified MMC segments are within desired shape and dimensional tolerances of the respective 3D CAD models. In some embodiments, the AM system forms the MMC segments under a vacuum, that is at less than ambient atmospheric pressure. In some embodiments, the AM system forms the MMC segments in an environment with an inert atmosphere. The vacuum and/or inert atmosphere for forming the MMC segments may inhibit oxidation reactions of the powder materials.

Although the MMC segments described herein may be formed by various AM systems, the following table gives specifications for the Arcam EBM Spectra H as a non-limiting example of the parameters and environment that may be utilized with the powder mixtures described herein to form the MMC segments:

TABLE 1

| | |
|---|---|
| Max. build size | 250 × 430 mm (D, H) |
| Max. beam power | 6 kW |
| Cathode type | Single crystalline |
| Minimum chamber pressure | 5 × 10 − 4 mbar |
| Typical build atmosphere | 4 × 10 − 3 mbar (partial pressure of He) |
| Power supply | 3 × 400 V, 32 A, 13 kVA |
| He consumption, build process | 5 liter/h |
| He consumption, ventilation | 150-200 L/build |
| Typical process temperature | 600-1,100° C. |
| range | |
| Size | 1,328 × 2,344 × 2,858 mm (D, W, H) |
| Weight | 2,915 kg |
| CAD interface | Standard STL |

According to the present disclosure, an MMC produced by AM optionally uses spherically shaped particles. All or substantially all of the hard particles and metal binder may be spherically shaped particles. For example, the hard particles may be spherical cast tungsten carbide (SCC) particles. Spherically shaped particles provide good flowability and packing. The term SCC may include carbide hard particles other than tungsten carbide, such as but not limited to, titanium carbide (TiC) and silicon carbide (SiC). With some direct sintering processes using laser or electron beam, however, the use of near spherical particles is envisioned, where the ratio of the equivalent diameter measured at a perpendicular position is between 0.7 and 1.0. The particles used could be individual hard particles or a blend of hard particles with the binder metal. The hard particles may be equal to or more than 27 vol %, 30 vol %, 36 vol %, 40 vol %, 50 vol %, 55 vol %, or up to 60 vol % of the completed MMC. The hard particles that are tungsten carbide (e.g., spherically cast tungsten carbide) may be approximately 40 wt %, 44 wt %, 45 wt %, 50 wt %, 55 wt %, 60 wt %, 65 wt %, 70 wt %, 75 wt %, or up 80 wt % of the completed MMC. If the densities of the hard particles and metal binder are significantly different, it is contemplated that the hard particles and metal alloy particles have similar weight. In such cases two different sizes of particles may be used-one for hard particles and the other for binder particles. It is also possible that the particle sizes for hard materials and binder materials may be different based on the thermal diffusivity values for a given direct energy sintering or melting process.

As mentioned herein, one or more embodiments of the present disclosure may use cast tungsten carbide in the MMC. Cast tungsten carbide may have approximately the eutectic composition between bitungsten carbide, W₂C, and monotungsten carbide, WC. Cast tungsten carbide can be made by resistance heating tungsten in contact with carbon. Available types of cast tungsten carbide include crushed cast tungsten carbide and spherical cast tungsten carbide. Processes for producing spherical cast carbide particles are described in U.S. Pat. Nos. 4,723,996 and 5,089,182, which are herein incorporated by reference. Briefly, tungsten may be heated in a graphite crucible having a hole through which a resultant eutectic mixture of W₂C and WC may drip. This liquid may be quenched in a bath of oil and may be subsequently comminuted or crushed to a desired particle size to form what is referred to as crushed cast tungsten carbide. In other processes, a mixture of tungsten and carbon is heated above its melting point into a constantly flowing stream which is poured onto a rotating cooling surface, typically a water-cooled casting cone, pipe, or concave turntable. The molten stream is rapidly cooled on the rotating surface and forms spherical particles of eutectic tungsten carbide, which are referred to as spherical cast tungsten carbide. The melting temperature of the SCC may be approximately 2525° C.

A eutectic mixture of WC and W₂C may include about 4.5 wt % carbon. Cast tungsten carbide used as a matrix powder may have a hypoeutectic carbon content of about 4 wt %. Thus, by way of example only, the cast tungsten carbide used in the mixture of tungsten carbides may include from 3.7 to 4.2 wt % carbon.

It is also envisioned that while one or more embodiments may have carbide particles that include or consist of cast tungsten carbide (spherical in particular, example embodiments), other embodiments may instead or also use other types of tungsten carbide, including, for example, macrocrystalline tungsten carbide, carburized tungsten carbide, or sintered tungsten carbide, cemented tungsten carbide, alone or in combination with each other and/or cast tungsten carbide. Various types of tungsten carbide materials described herein may be selected so as to provide a bit that is tailored for a particular drilling application. For example, the type (e.g., cast, cemented, sintered, or macrocrystalline tungsten carbide), shape, and/or size of carbide particles used in the formation of a MMC may affect the material properties of the formed body, including, for example, fracture toughness, transverse rupture strength, and wear and erosion resistance.

A continuous metal matrix of the MMC may be formed from a metal binder material. The metal binder material may be between 30 to 72.5 vol % of the completed MMC. Suitable metals include any transition metals, main group metals, and alloys thereof. For example, nickel, iron, cobalt, titanium, or copper may be used as the major constituents. As discussed in detail below, the metal binder material of sample materials is a nickel-based binder having greater than 6.5 wt % silicon. For MMCs formed by EBM process, the metal binder material is a powder or powder mixture. The one or more powders of the metal binder material for an EBM process may be spherical and formed by a process such as a gas atomization process. The silicon may be alloyed with or may be a separate powder constituent from the nickel within the binder powder. In some embodiments, the nickel-based binder does not include boron. The silicon content may be increased to reduce the melting temperature of the binder and to reduce the dissolution of the carbide particles therein during melting of the binder. The silicon content may be increased to increase the fluidity of the molten binder.

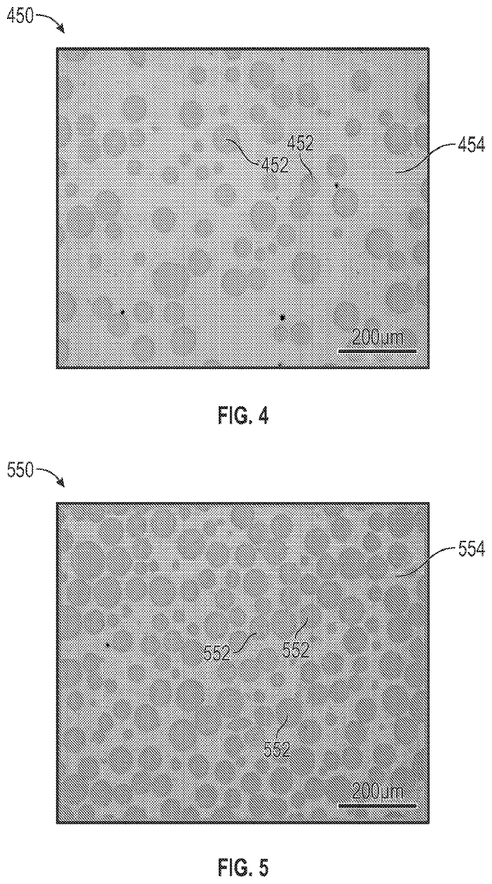

The hard particles and the binder of the MMC have been studied to develop the desired compositions described herein having increase wear resistance and strength. FIGS. 4 and 5 illustrate optical micrographs of example MMCs having compositions described below. The first sample 450 of FIG. 4 is an MMC additively manufactured by EBM with hard particles 452 of nominal size less than 50 micrometers within a nickel-based binder 454. The hard particles 452 are spherical, cast tungsten carbide (SCC) particles. The hard particles 452 make up approximately 30 vol % of the MMC, with the binder 454 forming the balance (70 vol %) of the MMC. The nickel-based binder 454 has between 5.5 to 6.5 wt % silicon, with nickel forming the balance (93.5 to 94.5 wt %) of the binder 454. The distribution of SCC particles within the first sample 450 is uniform with a mean free path of approximately 97 μm. The second sample 550 of FIG. 5 is an MMC additively manufactured by EBM with hard particles 552 of nominal size less than 50 micrometers within a nickel-based binder 554. The hard particles 552 are SCC particles. The hard particles 552 make up approximately 65 wt % (50 vol %) of the MMC, with the binder 554 forming the balance (35 wt %/50 vol %) of the MMC. The nickel-based binder 554 has between 7 to 7.5 wt % silicon, with nickel forming the balance (92.5 to 93.0 wt %) of the binder 554. The distribution of SCC particles within the second sample 550 is uniform with a mean free path of approximately 41 μm, which is approximately 42% of the mean free path of the first sample 450.

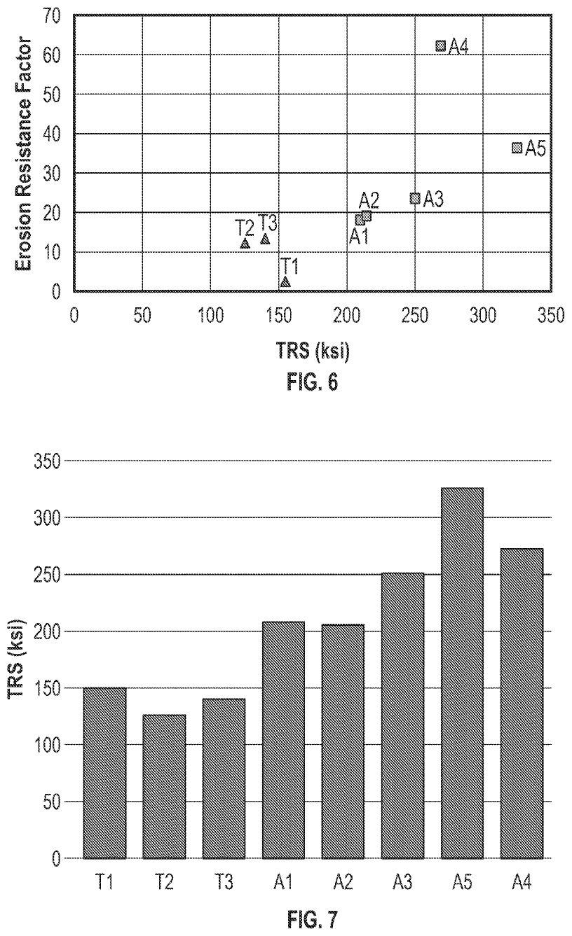

The graph 650 of FIG. 6 illustrates the transverse rupture strength (TRS) and an erosion resistance factor for multiple materials, both traditional materials used for drill bits or downhole tools and new materials. As discussed herein the TRS of materials have been determined through one or both of ASTM B528 and ASTM B406. The erosion resistance factor is a normalized result from a jet erosion test analogy to ASTM G76 that measures the volume loss per unit of sand used to compare the erosion resistance property of the materials. For example, erosion rates may be determined using a modified ASTM G76 test, in which water (instead of air) is used for the fluid. Sand particles are 50/70 mesh Ottawa sand, with test times of 6 to 12 minutes. The fluid and entrained sand particles are directed at the test material at an angle of 150°. The distance between the nozzle exit and the test material is 2 in. (5.08 cm). The jet velocity is approximately 200 ft/s (61 m/s), and the sand consumption is approximately 0.75 lb/min (0.34 kg/min). The erosion rate value for the test material is normalized by the weight of sand used to determine the erosion resistance factor. The erosion resistance factor is a normalized value that is inversely related to the tested erosion rate.

The traditional materials T1 and T2 are infiltrated matrix materials. For example, T1 is an infiltrated matrix material having a mixture of fine tungsten carbide and crushed tungsten carbide that is infiltrated with a copper-based binder having manganese, nickel, and zinc. T2 is an infiltrated matrix material having a coarse crushed tungsten carbide (80/120 mesh) that is infiltrated with same the copper-based binder. T3 is a hardfacing material that may be applied by a welding process, such as oxygen-acetylene spray, to a bit. T3 may have a coarse spherical tungsten carbide (210-400 μm) with a nickel, chromium, iron, silicon, and boron binder. The TRS of the traditional materials T1-T3 is less than or equal to 155 ksi, and the erosion resistance factor is less than 14.

Additively manufactured materials have been developed with increased TRS and erosion resistance factors relative to the traditional materials. TRS relates to the strength of the material and the ability to operate in the downhole environment without failure. The erosion resistance factor relates to the ability to maintain the pocket structure around cutting elements. The additively manufactured MMCs were formed by EBM, and include hard particles and metal binder having the compositions described below in Table 2:

TABLE 2

| | | | | Erosion |
|---|---|---|---|---|
| AM Material | Tungsten Carbide | Binder | TRS | Resistance |
| Name | wt % (vol %) | composition | (ksi) | Factor |
| A1 | 40 wt % (27.5 | 94.0-95 wt % Ni | 210 | 18.18 |
| | vol %) | 3.5-4.0 wt % Si | | |
| | | 1.5-2.0 wt % B | | |
| A2 | 44 wt % (30 | 94.0-95 wt % Ni | 205 | 20.15 |
| | vol %) | 3.5-4.0 wt % Si | | |
| | | 1.5-2.0 wt % B | | |
| A3 | 44 wt % (30 | 93.5-94.5 wt % Ni | 250 | 23.8 |
| | vol %) | 5.5-6.5 wt % Si | | |
| A4 | 65 wt % (50 | 92.5-93.0 wt % Ni | 270 | 62.5 |
| | vol %) | 7.0-7.5 wt % Si | | |
| A5 | 44 wt % (30 | 92.5-93.0 wt % Ni | 326 | 36.6 |
| | vol %) | 7.0-7.5 wt % Si | | |

As shown in FIG. 6, the materials A1-A5 exhibit a TRS greater than 200 ksi and greater than the traditional materials T1-T3. Increasing the silicon content of the binder relates to increasing TRS and erosion resistance. Increasing the hard particle content also relates to increasing erosion resistance yet decreasing TRS. Interestingly, increasing the silicon content of the binder around 7.5 wt % with A5 appears to have an unexpected increase to the TRS that is 30% greater than the A3 material having 5.5-6.5 wt % silicon with the same hard particle content, and the TRS of the A5 material is 20% greater than the A4 material having a greater hard particle content yet the same binder. Moreover, the erosion resistance factor of the A5 material is 50% greater than the erosion resistance factor of the A3 material with less silicon in the binder.

FIG. 7 is a chart illustrating the results of further TRS testing of the materials T1, T2, T3, A1, A2, A3, A4, and A5 having different quantities of hard particles mixed with the metal binder. The TRS of the traditional materials T1-T3 is less than or equal to 155 ksi, as with the samples shown in FIG. 6. The TRS of the AM MMCs A1-A3, A4, and A5 is greater than 200 ksi, as with the samples shown in FIG. 6. However, the TRS of A5: 326 ksi is greater than the TRS of A4: 270 ksi. The A5 MMC is formed by EBM with 44 wt % SCC hard particles (30 vol %) and 56 wt % nickel-based binder having between 7-7.5 wt % silicon, and the A4 MMC is formed by EBM with 65 wt % SCC hard particles (50 vol %) and 35 wt % nickel-based binder having between 7-7.5 wt % silicon. While increasing the hard particle content in the MMC is expected to increase the erosion resistance factor, it is desirable to increase both the erosion resistance factor and the TRS. The TRS of A5 is unexpectedly about 20% greater than the TRS of A4 which has fewer hard particles within the same binder. Moreover, the TRS of A5 is more than twice the TRS of the traditional materials T1-T3.

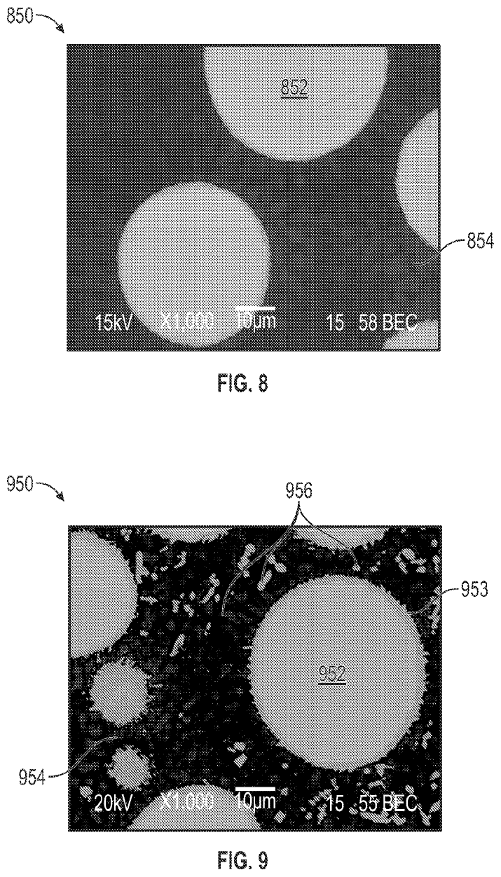

FIG. 8 illustrates a scanning electron microscopic image 850 of the A1 MMC having the nickel-based binder with silicon and boron. The hard particles 852 in the image 850 show a smooth circular surface 853, corresponding to the cross-section of the SCC hard particles 852. The binder 854 in the image 850 exhibits a uniform coloring, suggesting a uniform composition after printing the A1 MMC. The melting point of the nickel-based binder with silicon and boron is approximately 1043° C.

FIG. 9 illustrates a scanning electron microscopic image 950 of the A5 MMC having the nickel-based binder with silicon yet without boron. The hard particles 952 in the image 950 show an irregular circular surface or reaction zone 953 between the hard particles 952 and the binder 954. The reaction zone 953 may be formed at least in part due to a softening or melting of the hard particles 952 during the EBM process. Moreover, the binder 954 in the image 950 exhibits a non-uniform coloring with various colored shapes between the SCC hard particles 952. The binder 954 of the A5 MMC exhibits scattered dispersoids 956 between the hard particles 952. The dispersoids 956 are believed to be dissociated WC or W₂C from the hard particles 952 and/or the precipitates of tungsten-rich Eta phase and/or nickel-rich Eta-phase within the binder 954. The dispersoids 956 have a greater strength and hardness than the binder 954 itself. The dispersoids 956 are smaller than the hard particles 952, yet also serve to increase the strength, hardness, and wear resistance of the A5 MMC material. That is, the distribution of the dispersoids 956 and the hard particles 952 throughout the binder 954 increase the hardness of the binder and increase the wear resistance of the A5 MMC material. The dispersoids 956 decrease the mean free path through the binder 954 of the MMC. The dispersoids 956 may form to have sizes in at least one dimension between 2 to 20 μm, between 5 to 15 μm, or up to 10 μm. The dispersoids 956 may fill a volumetric percentage of the binder 954 within a range, such as greater than 2%, between 5% to 30%, 10% to 25%, or 15% to 20% of the binder volume.

Additionally, the reaction zone 953 for the A5 MMC material is a stronger bond between the hard particles 952 and the binder 954 than the bonding between the hard particles 852 and the binder of the A1 MMC material shown in FIG. 8. Thus, the reaction zone 953 and the dispersoids 956 of the A5 MMC material shown in the image 950 increase the strength and wear resistance of the A5 MMC material. The melting point of the nickel-based binder for the A5 MMC material with >6.5 wt % silicon is approximately 1250° C. The higher melting temperature for the A5 MMC material may facilitate the formation of the reaction zone 953 and the dispersoids 956 due to higher temperatures of the EBM process.

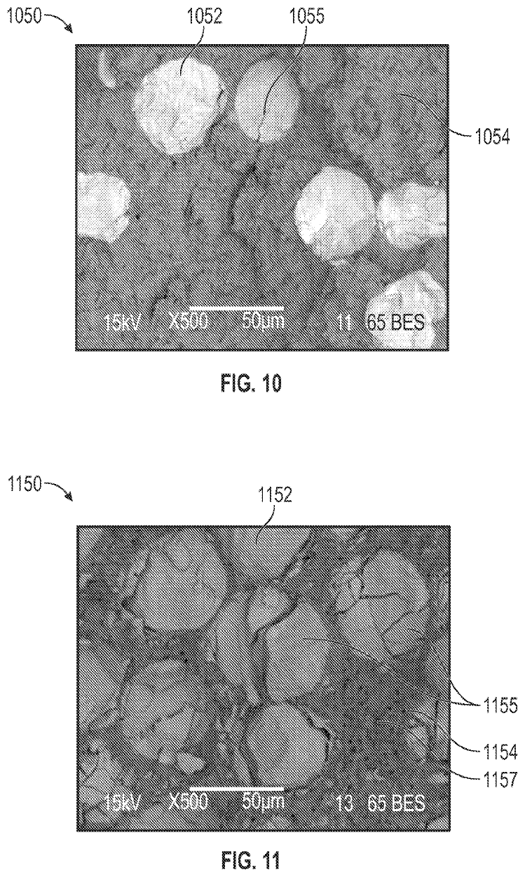

FIG. 10 is a scanning electron microscope image 1050 of a fractured surface of the A2 MMC. As noted above, the A2 MMC has 44 wt % SCC hard particles (30 vol %) and nickel-based binder with silicon and boron. Some of the hard particles 1052 in the image 1050 show transgranular fractures 1055. Additionally, the fracture surface of the binder 1054 is consistent with a brittle fracture due to the sharp edges on the binder surface. In sharp contrast, FIG. 11 is a scanning electron microscope image 1150 of a fractured surface of the A3 MMC. As noted above, the A3 MMC has 44 wt % SCC hard particles (30 vol %) 1152 and nickel-based binder 1154 without boron, and between 5.5-6.5 wt % silicon. The fracture surface in the image 1150 illustrates transgranular fractures 1155 across the hard particles. The fracture surface of the binder 1154 shows dimpled features 1157, which are consistent with a ductile fracture of the binder 1154. Moreover, the fracture surface 1154 of the binder 1154 is rougher than the fracture surface of the binder 1054. Accordingly, the binder 1154 of the A3 MMC appears to absorb of the stress to failure than the binder 1054 of the A2 MMC with boron and less silicon.

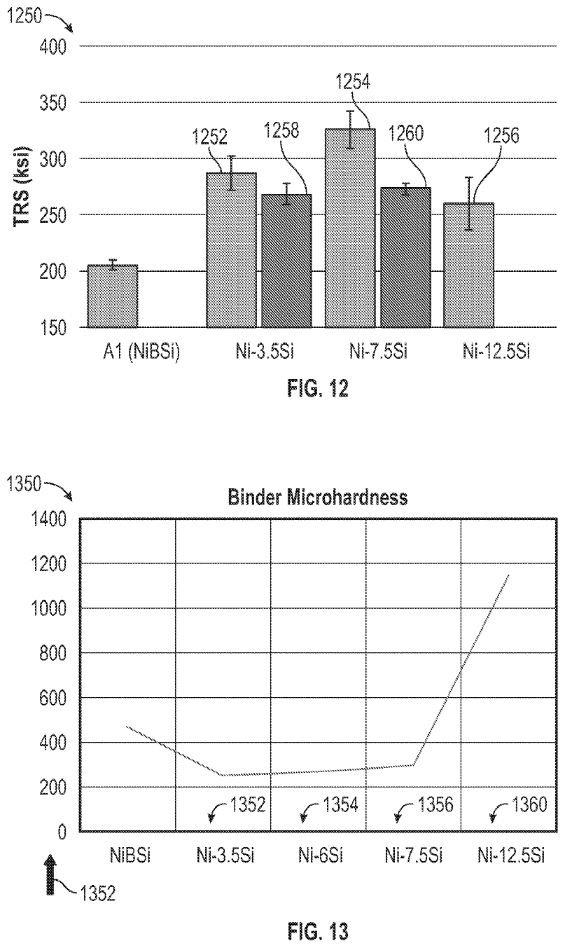

The chart 1250 of FIG. 12 illustrates the TRS of multiple MMC samples with binders having various quantities of silicon. The TRS of an A1 MMC sample having 44 wt % SCC (30 vol %) and a nickel-based binder with silicon and boron is 205 ksi. Relative to the A1 MMC sample, the second sample 1252 removes the boron and adjusts the silicon in the nickel-based binder to 3.5 wt % of the binder. The TRS of the second sample 1252 is thereby increased to 287 ksi. The third sample 1254 further increases the silicon in the nickel-based binder to 7.5 wt % of the binder, which increases the TRS of the third sample 1254 to 326 ksi. However, increasing the silicon in the nickel-based binder to 12.5 wt % of the binder decreases the TRS of a fourth sample 1256 to 260 ksi, which is less than the TRS of the second sample 1252 having 3.5 wt % silicon in the binder.

The results of additional MMC samples 1258, 1260 having 65 wt % SCC (50 vol %) are shown in chart 1250. A fifth sample 1258 having 65 wt % SCC (50 vol %) and a nickel-based binder with 3.5 wt % silicon tested with a TRS of 268 ksi, which is less than the second sample 1252 with the same binder composition. A sixth sample 1260 having 65 wt % SCC and a nickel-based binder with 7.5 wt % silicon tested with a TRS of 268 ksi, which is less than the third sample 1254 with the same binder composition. Furthermore, a seventh sample having 65 wt % SCC and a nickel-based binder with 12.5 wt % silicon was produced, but the additively manufactured MMC sample exhibited cracks and was unable to be tested. Accordingly, having too much silicon in the binder is incompatible with large quantities of tungsten carbide in the MMC. That is, the MMC material having 65 wt % SCC (50 vol %) and the nickel-based binder with 12.5 wt % silicon did not have sufficient ductility to facilitate formation of a testable MMC sample.

As shown above, increasing the silicon in the nickel-based binder to 7.5 wt % may increase the TRS of the MMC formed by an EBM process. However, the effect of the silicon content in the binder on the microhardness of the binder is different than the effect on the TRS. The chart 1350 of FIG. 13 illustrates the Knoop microhardness 1352 in accordance with ASTM E384 for multiple binders having different compositions. A first binder having 94-95 wt % nickel, 3.5-4.0 wt % silicon, and 1.5-2.0 wt % boron has a microhardness of 465. A second binder 1354 having 96.5 wt % nickel and 3.5 wt % silicon without boron has a microhardness of 250. That is, removing the boron alone appears to decrease the microhardness of the binder. Increasing the silicon for the third binder 1356 having 94 wt % nickel and 6 wt % silicon increases the microhardness of the binder by only 6.6% to 266. Further increasing the silicon for the fourth binder 1358 having 92.5 wt % nickel and 7.5 wt % silicon increases the microhardness of the binder by 11% to 297. However, increasing the silicon for the fifth binder 1360 having 87.5 wt % nickel and 12.5 wt % silicon increases the microhardness of the binder by 285%. Thus, optimizing the microhardness of the binder alone through the addition of silicon would prioritize binder compositions having greater than 7.5 wt % silicon or even binder compositions having boron.

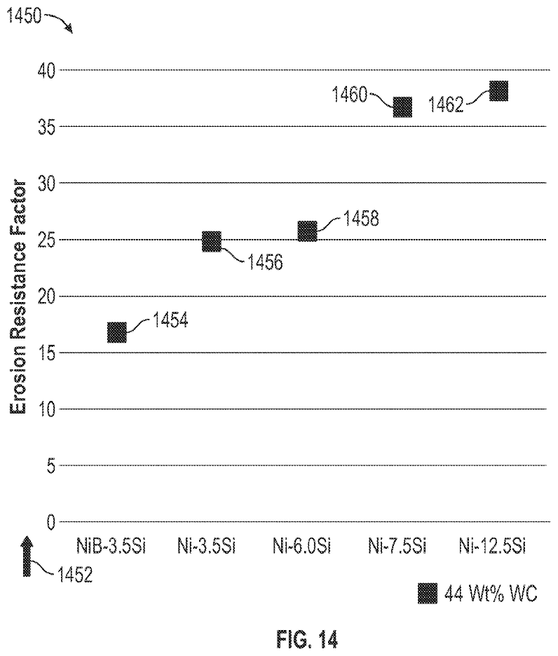

It is desirable to increase the erosion resistance factor of materials used for drill bits and drilling tools. FIG. 14 illustrates a chart 1450 of the erosion resistance factor 1452 for MMC materials having different binder compositions described above. Increasing the hard particles in the mixture is known to increase the erosion resistance factor, yet too many hard particles in the mixture may lead to brittleness. A first sample 1454 having a binder with 94-95 wt % nickel, 3.5-4.0 wt % silicon, and 1.5-2.0 wt % boron has an erosion resistance factor of 16.8. A second sample 1456 having a second binder with 96.5 wt % nickel and 3.5 wt % silicon without boron has an erosion resistance factor of 24.8. Thus, removing the boron increases the erosion resistance factor. A third sample 1458 having a third binder with 94 wt % nickel and 6 wt % silicon increases the erosion resistance factor by 4% to 25.7. A fourth sample 1460 having a fourth binder with 92.5 wt % nickel and 7.5 wt % silicon increases the erosion resistance factor by 42% to 36.6. A fifth sample 1462 having a fifth binder with 87.5 wt % nickel and 12.5 wt % silicon increases the erosion resistance factor by 4% to 38. Accordingly, there is a significant and unexpected benefit to the erosion resistance factor by increasing the silicon content in the binder to approximately 7.5 wt %, yet further increases in the silicon content in the binder do not appear to significantly affect the erosion resistance factor.

As discussed herein, MMCs formed having a nickel-based metal binder powder with between 6.0 wt %-12.5 wt % silicon have been developed with increased strength and increased erosion resistance. Hard particles, such as SCC, TiC, or SiC, may form between 27-60 vol % of the MMC. For example, SCC hard particles may form between 40-70 wt % of the MMC. The nickel-based binder with silicon and no boron may facilitate higher temperature printing of an MMC, thereby enabling the formation of a reaction zone around the hard particles of the MMC that are believed to increase the strength of the MMC. Higher temperatures may facilitate the formation of dispersoids from the hard particles within the molten binder to increase the strength and wear resistance of the MMC. Additionally, or in the alternative, higher temperatures of the nickel-based binder having more than 6.5 wt % silicon during printing of an MMC may generate precipitates of the binder (e.g., nickel-rich Eta-phase, tungsten-rich Eta-phase) that increase the strength and wear resistance of the MMC. Furthermore, MMCs with the nickel-based binder powder having near 12.5 wt % silicon appear to exhibit brittleness, yet do not have significantly greater erosion resistance relative to MMCs with between 6.0 wt % to 10.0 wt % silicon in the nickel-based binder powder. MMCs using a nickel-based metal binder powder with between 6.0 to 10.0 wt % silicon exhibit increased strength and erosion resistance desirable for use with downhole tools than other metal binder powders currently available.

One or more specific embodiments of the present disclosure are described herein. These described embodiments are examples of the presently disclosed techniques. Additionally, in an effort to provide a concise description of these embodiments, not all features of an actual embodiment may be described in the specification. It should be appreciated that in the development of any such actual implementation, as in any engineering or design project, numerous embodiment-specific decisions will be made to achieve the developers' specific goals, such as compliance with system-related and business-related constraints, which may vary from one embodiment to another. Moreover, it should be appreciated that such a development effort might be complex and time consuming, but would nevertheless be a routine undertaking of design, fabrication, and manufacture for those of ordinary skill having the benefit of this disclosure.

Additionally, it should be understood that references to “one embodiment” or “an embodiment” of the present disclosure are not intended to be interpreted as excluding the existence of additional embodiments that also incorporate the recited features. For example, any element described in relation to an embodiment herein may be combinable with any element of any other embodiment described herein. Numbers, percentages, ratios, or other values stated herein are intended to include that value, and also other values that are “about” or “approximately” the stated value, as would be appreciated by one of ordinary skill in the art encompassed by embodiments of the present disclosure. A stated value should therefore be interpreted broadly enough to encompass values that are at least close enough to the stated value to perform a desired function or achieve a desired result. The stated values include at least the variation to be expected in a suitable manufacturing or production process, and may include values that are within 5%, within 1%, within 0.1%, or within 0.01% of a stated value.

A person having ordinary skill in the art should realize in view of the present disclosure that equivalent constructions do not depart from the spirit and scope of the present disclosure, and that various changes, substitutions, and alterations may be made to embodiments disclosed herein without departing from the spirit and scope of the present disclosure. Equivalent constructions, including functional “means-plus-function” clauses are intended to cover the structures described herein as performing the recited function, including both structural equivalents that operate in the same manner, and equivalent structures that provide the same function. It is the express intention of the applicant not to invoke means-plus-function or other functional claiming for any claim except for those in which the words ‘means for’ appear together with an associated function. Each addition, deletion, and modification to the embodiments that falls within the meaning and scope of the claims is to be embraced by the claims.

The terms “approximately,” “about,” and “substantially” as used herein represent an amount close to the stated amount that is within standard manufacturing or process tolerances, or which still performs a desired function or achieves a desired result. For example, the terms “approximately,” “about,” and “substantially” may refer to an amount that is within less than 5% of, within less than 1% of, within less than 0.1% of, and within less than 0.01% of a stated amount. Further, it should be understood that any directions or reference frames in the preceding description are merely relative directions or movements. For example, any references to “up” and “down” or “above” or “below” are merely descriptive of the relative position or movement of the related elements.

The present disclosure may be embodied in other specific forms without departing from its spirit or characteristics. The described embodiments are to be considered as illustrative and not restrictive. The scope of the disclosure is, therefore, indicated by the appended claims rather than by the foregoing description. Changes that come within the meaning and range of equivalency of the claims are to be embraced within their scope.

What is claimed is:

1. An additively manufactured metal matrix composite (MMC) comprising:
hard particles comprising greater than 27 vol % of the MMC, wherein the hard particles are spherically shaped; and
a binder comprising nickel and silicon, wherein the binder comprises less than 73 vol % of the MMC, wherein the silicon comprises more than 6.0 wt % of the binder and less than 12.5 wt % of the binder.

2. The MMC of claim 1, wherein the transverse rupture strength (TRS) of the MMC is greater than 300 ksi, and the erosion resistance factor is greater than 30.

3. The MMC of claim 1, comprising a plurality of layers, wherein each layer of the plurality of layers comprises the hard particles dispersed throughout the binder, and each layer is additively formed proximate another layer of the plurality of layers.

4. The MMC of claim 1, wherein the hard particles comprise spherical cast tungsten carbide.

5. The MMC of claim 1, wherein the hard particles comprise between 30 vol % to 37 vol % of the MMC, and the silicon comprises between 7.0 wt % to 8.0 wt % of the binder.

6. The MMC of claim 1, wherein the hard particles comprise greater than or equal to 50 vol % of the MMC.

7. The MMC of claim 1, wherein the binder consists essentially of nickel and silicon, and the silicon comprises between 6.5 wt % to 9.0 wt % of the binder.

8. The MMC of claim 1, wherein the silicon comprises between 6.5 wt % to 9.0 wt % of the binder.

9. The MMC of claim 1, wherein the hard particles comprise titanium carbide, silicon carbide, or any combination thereof.

10. The MMC of claim 1, comprising dispersoids dispersed throughout the binder, wherein the dispersoids have a length in a range between 5 to 15 μm, wherein the dispersoids comprise a nickel-rich eta phase of the binder, precipitates of the hard particles, or any combination thereof.

11. The MMC of claim 1, comprising dispersoids dispersed throughout the binder, wherein the dispersoids fill a volumetric percentage of the binder between 10% to 25% of the binder volume.

12. Additively manufacturing a metal matrix composite (MMC) comprising:
printing a first layer of the MMC;
printing a second layer of the MMC at least partially on the first layer, wherein each layer of the MMC comprises a mixture of hard particles and a binder powder, wherein the hard particles comprise between 30 vol % and 50 vol % of the MMC, the binder powder comprises nickel and silicon, the silicon comprises more than 6.0 wt % of the binder powder and less than 10.0 wt % of the binder powder.

13. Additively manufacturing the MMC of claim 12, wherein printing the first layer of the MMC and printing the second layer of the MMC comprise using an electron beam melting system.

14. Additively manufacturing the MMC of claim 12, comprising forming dispersoids dispersed throughout the first layer and the second layer, wherein the dispersoids have a length in a range between 5 to 15 μm, wherein the dispersoids comprise a nickel-rich eta phase of the binder powder, precipitates of the hard particles, or any combination thereof.

15. Additively manufacturing the MMC of claim 12, wherein the hard particles comprise spherical cast tungsten carbide particles.

16. Additively manufacturing the MMC of claim 12, wherein the binder powder consists essentially of nickel and silicon, and the silicon comprises between 7.0 wt % to 9.0 wt % of the binder powder.

17. A drilling tool comprising an additively manufactured metal matrix composite (MMC), the MMC comprising:
hard particles comprising greater than 44 wt % of the MMC, wherein the hard particles comprise spherically shaped cast tungsten carbide particles; and
a binder comprising nickel and silicon, wherein the binder comprises less than 56 wt % of the MMC, the silicon comprises more than 7.0 wt % of the binder and less than 10.0 wt % of the binder.

18. The drilling tool of claim 17, wherein the TRS of the MMC is greater than 300 ksi, and the erosion resistance factor is greater than 30.

19. The drilling tool of claim 18, wherein the hard particles comprise less than 50 wt % of the MMC and the silicon comprises between 7.5 wt % of the binder and 8.0 wt % of the binder.

20. The drilling tool of claim 17, wherein the binder is without boron.
